(19) United States
(12) Patent Application Publication
(10) Pub. No.: US 2009/0161269 A1
(43) Pub. Date: Jun. 25, 2009

(54) MAGNETORESISTIVE SENSOR HAVING AN ENHANCED FREE LAYER STABILIZATION MECHANISM

(76) Inventors: James Mac Freitag, Sunnyvale, CA (US); Mustafa Michael Pinarbasi, Morgan Hill, CA (US)

Correspondence Address: ZILKA-KOTAB, PC- HIT, P.O. BOX 721120, SAN JOSE, CA, 95172-1120, US

(21) Appl. No.: 11/962,599

(22) Filed: Dec. 21, 2007

(51) Int. Cl. G11B 5/33

(52) U.S. Cl. 360/324.12

(57) ABSTRACT

A magnetoresistive sensor having an improved hard bias stabilization structure. The sensor includes a hard bias layer that is formed on a surface that has been treated to form it with an anisotropic texture that induces a magnetic anisotropy oriented parallel with the air bearing surface. This magnetic anisotropy is further aided by a shape induced magnetic anisotropy caused by configuring the hard bias layers to have a width parallel with the air bearing surface that is larger than a stripe height of the hard bias layer measured perpendicular to the air bearing surface.

### FIELD OF THE INVENTION

The present invention relates to free layer biasing in a magnetoresistive sensor, and more particularly to a magnetically anisotropic hard bias layer.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk and when the disk rotates, air adjacent to the surface of the disk moves along with the disk. The slider flies on this moving air at a very low elevation (fly height) over the surface of the disk. This fly height is on the order of Angstroms. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head includes a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic impressions in tracks on the moving media, such as in circular tracks on the aforementioned rotating disk.

In recent read head designs a spin valve sensor, also referred to as a giant magnetoresistive (GMR) sensor, has been employed for sensing magnetic fields from the rotating magnetic disk. This sensor includes a nonmagnetic conductive layer, hereinafter referred to as a spacer layer, sandwiched between first and second ferromagnetic layers, hereinafter referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is biased parallel to the ABS, but is free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos θ, where θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

### SUMMARY OF THE INVENTION

The present invention provides a magneoresistive sensor having an improved hard bias stabilization structure. The sensor includes a hard bias layer that is formed on a surface that has been treated to form it with an anisotropic texture that induces a magnetic anisotropy oriented parallel with the air bearing surface. This magnetic anisotropy is further aided by a shape induced magnetic anisotropy caused by configuring the hard bias layers to have a width parallel with the air bearing surface that is larger than a stripe height of the hard bias layer measured perpendicular to the air bearing surface.

This novel biasing scheme advantageously allows the hard bias layer to be formed over an under-layer such as Ru that results in a high quality hard bias material having a high magnetic squareness ratio. In order to provide optimal shape enhanced anisotropy, the width of the hard bias layer measured parallel with the air bearing surface is preferably at least 4 times the stripe height of the hard bias layer measured perpendicular to the air bearing surface.

These and other advantages and features of the present invention will be apparent upon reading the following detailed description in conjunction with the Figures.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 3-3 of FIG. 2, illustrating the location of a magnetic head thereon;

FIG. 3 is an ABS view of a magnetic sensor according to an embodiment of the present invention taken from circle 3 of FIG. 2;

FIG. 4 is a top down view of a sensor stack and hard bias layers 44 of FIG. 3;

FIGS. 5-9 are ABS cross sectional views of a magnetoresistive sensor shown in various intermediate stages of manufacture illustrating a method of manufacturing a sensor according to the embodiment as illustrated with reference to FIG. 3;

FIG. 10 is a cross sectional view illustrating a method of forming an anisotropic texture on a surface in order to induce a magnetic anisotropy in a material deposited thereon;

FIG. 11 is a perspective view of the method of forming an anisotropic texture on a surface in order to induce a magnetic anisotropy in a material deposited thereon;

FIG. 12 is a cross sectional view illustrating an anisotropic texture on a surface that might be formed by the method illustrated in FIGS. 10 and 11; and

FIG. 13 is a top down view of a sensor stack, hard bias layer and mask structure, further illustrating a method for manufacturing a magnetoresistive sensor according to an embodiment of the invention.

### BEST MODE FOR CARRYING OUT THE INVENTION

The following description is of the best embodiments presently contemplated for carrying out this invention. This description is made for the purpose of illustrating the general principles of this invention and is not meant to limit the inventive concepts claimed herein.

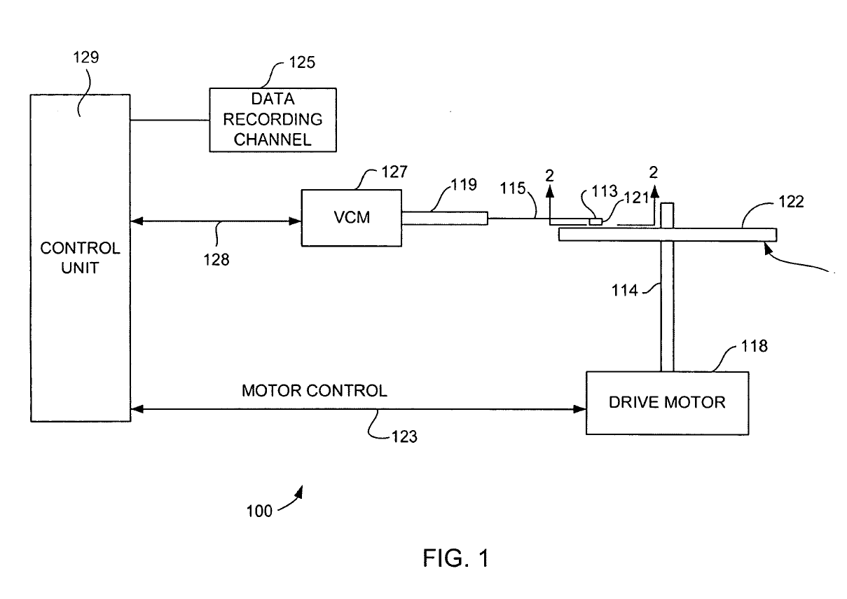

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

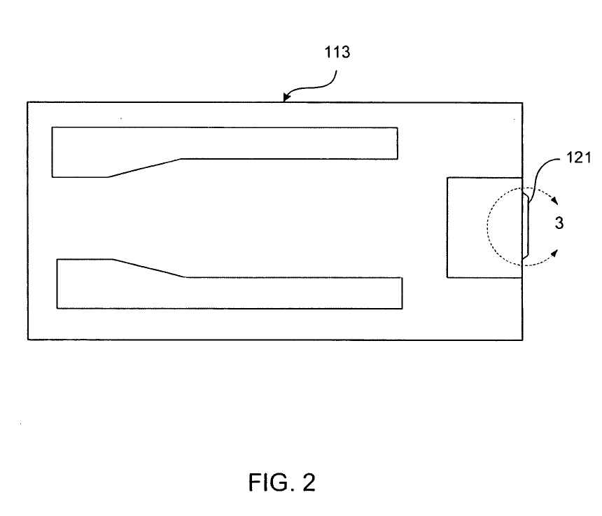

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

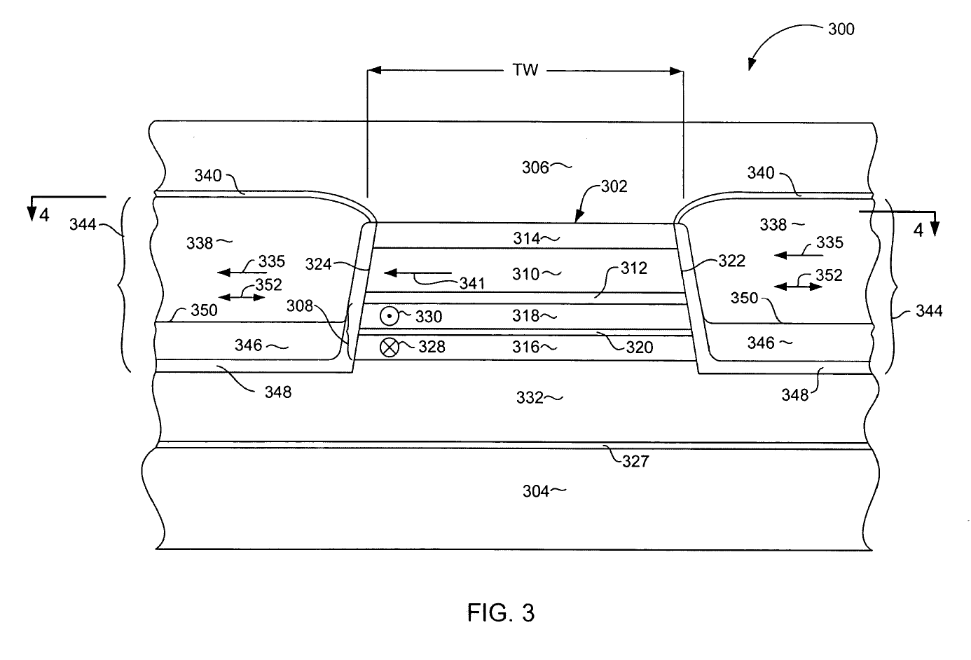

With reference now to FIG. 3, a magnetoresistive sensor 300 according to an embodiment of the invention includes sensor stack 302 sandwiched between first and second electrically conductive lead layer layers 304, 306. The lead layers 304, 306 can be constructed of an electrically conductive magnetic material such as NiFe so that they can function as magnetic shields as well as electrically conductive leads. Although the sensor is being described herein as a current perpendicular to plane sensor in which current flows perpendicular to the planes of the sensor layers, it could also be embodied in a current in plane sensor (CIP) in which case the sense current would flow parallel with the planes of the sensor layers.

The sensor stack 302 includes a magnetic pinned layer structure 308 and a magnetic free layer 310. A non-magnetic electrically conductive spacer layer 312, such as Cu, is sandwiched between the free layer 310 and the pinned layer structure 308. The invention can also be embodied in a tunnel valve, in which case the layer 312 would be a thin, non-magnetic, electrically insulating barrier layer. A capping layer 314, such as Ta, may be provided at the top of the sensor stack 302 to protect the sensor from damage during manufacturing, such as from corrosion during subsequent annealing processes.

The pinned layer 308 can be a simple pinned structure or an antiparallel (AP) pinned structure and is preferably an AP pinned structure including first and second magnetic layers (AP1) 316, and (AP2) 318 which may be for example CoFe antiparallel coupled across a thin AP coupling layer 320 such as Ru. The free layer 310 can be constructed of various magnetic materials such as NiFe or CoFe, and may include layers of CoFe and NiFe, preferably with a layer of CoFe or Co adjacent to the spacer 312 for optimal sensor performance.

As can be seen with reference to FIG. 3, the sensor stack 302 has first and second laterally opposed side walls 322, 324 that define the track-width or active area of the sensor. A layer of antiferromagnetic material (AFM) 332 such as PtMn, IrMn or IrMnCr formed at the bottom of the sensor stack 302 is exchange coupled with the AP1 layer 316. The AFM layer, when exchange coupled with the AP1 layer 316 strongly pins the magnetic moment of the AP1 layer 316 as indicated by arrowhead 328. This in turn strongly pins the moment 330 of the AP2 layer 318 by antiparallel coupling across the AP coupling layer 320. The AFM layer 332 may be formed on a seed layer 327 constructed of a material that is chosen to initiate a desired crystallographic structure in the AFM layer 332.

With continued reference to FIG. 3, the sensor 300 includes a hard bias structure 344, formed at each side of the sensor stack 302. Each of the hard bias structures 344 includes a hard magnetic, bias layers (HB layers) 338. A layer 348 of electrically insulating material such as alumina is formed over each of the sides 322, 324 of the sensor stack, and over the AFM 332 to prevent sense current from being shunted through the hard bias layer 338. A capping layer 340 such as Ta may be formed over each of the hard bias layers 338 to protect the underlying hard bias layer 338 during manufacture. The HB layers 338 can be constructed of various hard magnetic materials and are preferably constructed of CoPt or an alloy containing Co, Pt and Cr, more specifically Co₈₀Pt₁₂Cr₈. The hard bias layers 338 are magnetized in a desired direction as indicated by arrows 335. The hard bias layers 338 are magnetostatically coupled with the free layer 310 to bias the magnetization of the free layer 310 in a direction parallel with the ABS as indicated by arrow 341.

With reference still to FIG. 3, the sensor 300 can be constructed as either a full mill design, where the sides 322, 324 of the sensor stack extend all of the way down to the bottom lead 304, or could be a partial mill design as shown wherein a portion of the sensor layers such as the AFM 332 or pinned layer 308 extend beyond the active area of the sensor.

The under-layer 346 is preferably constructed of Ru, and may have a thickness of 10 to 150 Angstroms or about 40 Angstroms. The under-layer 346 has a surface 350 that has been treated to form it with an anisotropic surface texture. This anisotropic surface texture (formed by a method that will be discussed in greater detail herein below) results in a desired magnetic anisotropy 352 in the above hard bias layer 338. This magnetic anisotropy 352 greatly enhances the robustness and stability of the magnetic bias field 335 provided by the hard bias layer 338.

Reliability of the sensor 300 is greatly impacted by the strength and effectiveness of the free layer stabilization from the hard bias layer 338. As devices become smaller, significant stabilization enhancement is needed. The present invention provides a sensor design that greatly enhances the hard bias layer robustness, while also maintaining optimal film properties for the hard bias layer 338. Previous hard bias designs have relied solely on hard bias layer coercivity. This has precluded the use of some of the best quality hard bias structures. For example, oriented hard bias material with a Ru under-layer exhibits a high orientation ratio but results in lower coercivity of about 900 Oe. Such a material has a lower coercivity, but a very high magnetic anisotropy as characterized by its squareness ratio.

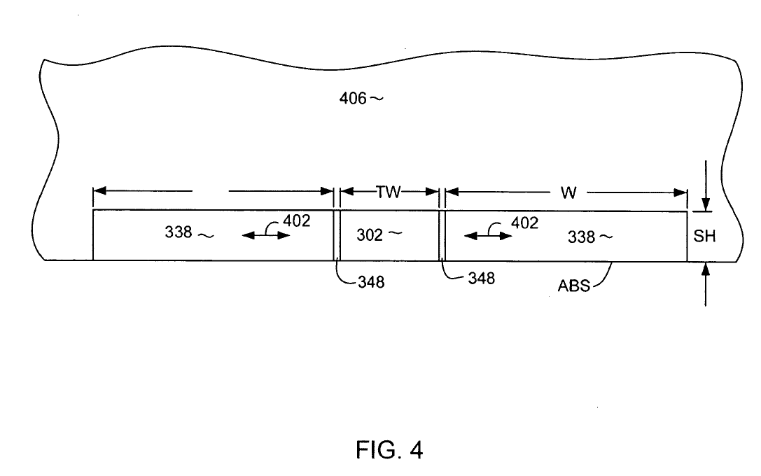

Since the hard axis coercivity is very small for such a hard bias structure, shape enhanced anisotropy can very effectively keep the magnetization 335 aligned as desired. FIG. 4 shows a top down view of a hard bias structure having a shape enhanced magnetic anisotropy 402 that combines with the texture induced anisotropy 352 described above with reference to FIG. 3, to produce an extremely robust sensor stabilization. As seen in FIG. 4, the sensor stack 302 and hard bias layers 338 share a common stripe height SH measured from the air bearing surface ABS to a back edge 404. Each of the hard bias layers 338 has a width dimension W measured laterally away from the sensor. The lateral width dimension W is significantly larger than the stripe height SH. Areas outside the sensor stack 302 and bias layers 338 can be a non-magnetic, electrically insulating fill layer 406

Therefore, as can be seen, each hard bias layer 338 has a rectangular shape with a long axis oriented parallel with the ABS in the cross-track direction, and this elongated shape results in a shape enhanced magnetic anisotropy 402 that is oriented along a desired direction parallel with the air bearing surface in the cross track direction (i.e. along the long axis of the hard bias layer) as shown. As mentioned above, this shape enhanced magnetic anisotropy combines with the texture induced anisotropy 352 (FIG. 3) to produce a very robust biasing structure, and allows the use of a high quality bias layer 338 formed on a Ru under-layer 346, with a desirable high squareness ratio. In order to maintain a desired, robust bias stabilization, the hard bias layer 338 is preferably constructed such that the ratio of W/SH is at least 4 although a lower or higher ratio will also provide significant biasing improvement, so long as the dimension W is greater than the dimension SH.

This new stabilization scheme, therefore, combines two very useful stabilization improvements and forms a very stable stabilization mechanism. This new structure utilizes the shape anisotropy 402 to enhance the hard bias stiffness and the texture induced anisotropy 352 to enhance its effectiveness and therefore provide better stabilization of the free layer magnetization 341. This new biasing mechanism also provides increased robustness against head-disk interaction because of the strong shape anisotropy, which is not dependent upon mechanical stresses or temperature effects. The enhancement from the shape anisotropy is expected to be over 3000 Oe for a stripe height value of about 90 nm and a hard magnet thickness of 30 nm. Lower stripe heights SH will result in even more robust biasing.

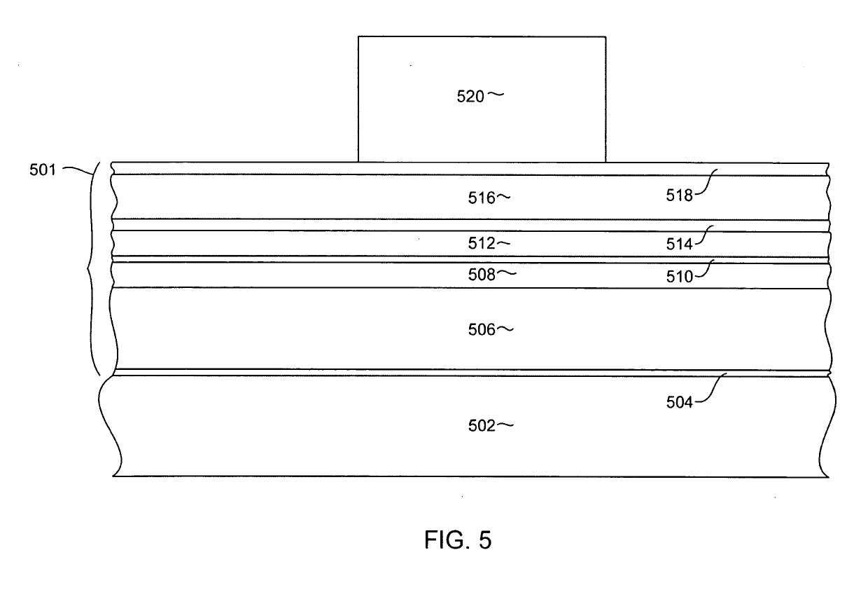

The texture enhanced anisotropy 352 described above with reference to FIG. 3, is described in greater detail below with reference to FIGS. 5-9, which illustrate a method for constructing a sensor such as that described above with reference to FIGS. 3 and 4. With particular reference to FIG. 5, a substrate 502 is provided. This substrate may be for example, the electrically conductive lead 304 described above with referenced to FIG. 3. A seed layer 504 such as Ta can be deposited over the substrate 502, followed by a layer of antiferromagnetic material 506 such as PtMn, IrMn or IrMnCr. Then, a first magnetic layer (AP1) 508 is deposited followed by a non-magnetic antiparallel coupling layer such as Ru 510 followed by a second magnetic layer (AP2) 512. Then, a non-magnetic electrically conducive spacer layer such as Cu 514 is deposited over the second magnetic layer 512, followed by a third magnetic layer (free layer) 516 and a capping layer such as Ta 518. As mentioned above, the invention can also be embodied in a tunnel valve sensor, in which case, the layer 514 would be a thin, electrically insulating, non-magnetic barrier layer instead of an electrically conductive spacer layer. The layers 504-518 can be collectively referred to as a sensor stack 501.

A mask structure 520 is then formed over the deposited layers 502-518. The mask structure 520 can include a photoresist or thermal image resist that has been photolithographically patterned and developed to have a width to define a track width of the sensor. The mask can also include one or more hard mask layers such as alumina (Al₂O₃) or silicon dioxide as well as image transfer layer such as a soluble polyimide such as DURIMIDE®.

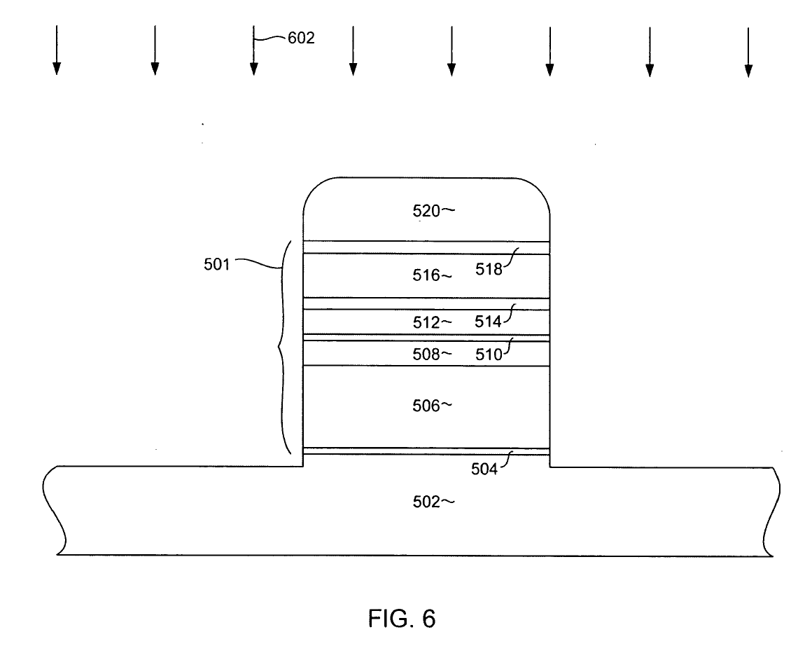

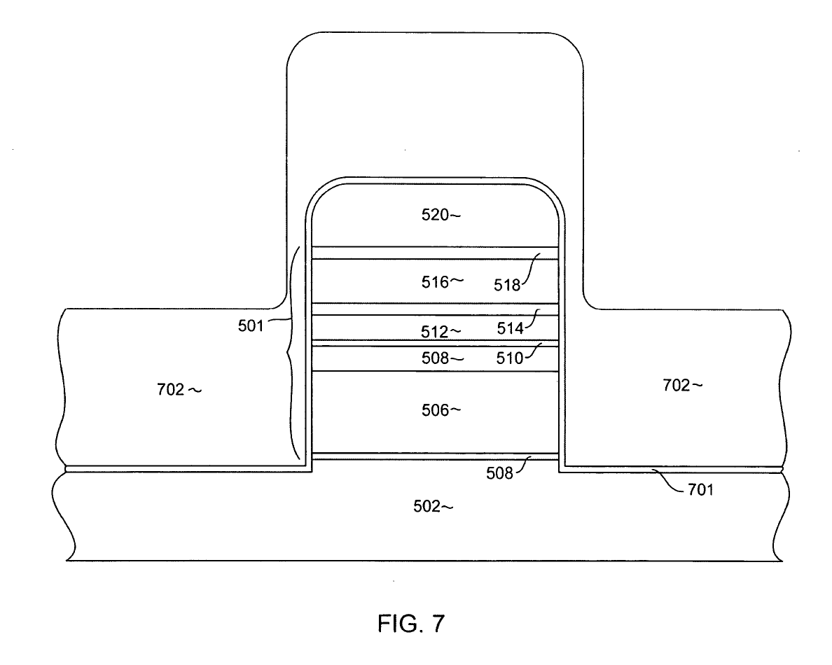

Then, with reference to FIG. 6, a material removal process such as ion milling is performed, using an ion beam 602 to remove portions of the sensor layers 504-518 that are not covered by the mask 520, the layers 504-518. Then, with reference to FIG. 7 a thin, electrically insulating layer such as alumina 701 is deposited preferably by a conformal deposition method such as atomic layer deposition (ALD) or chemical vapor deposition (CVD). A under-layer material 702, is then deposited over the insulation layer 701. The under-layer material 702 is preferably Ru, and can also be CrMo, Ta, or a combination of these materials.

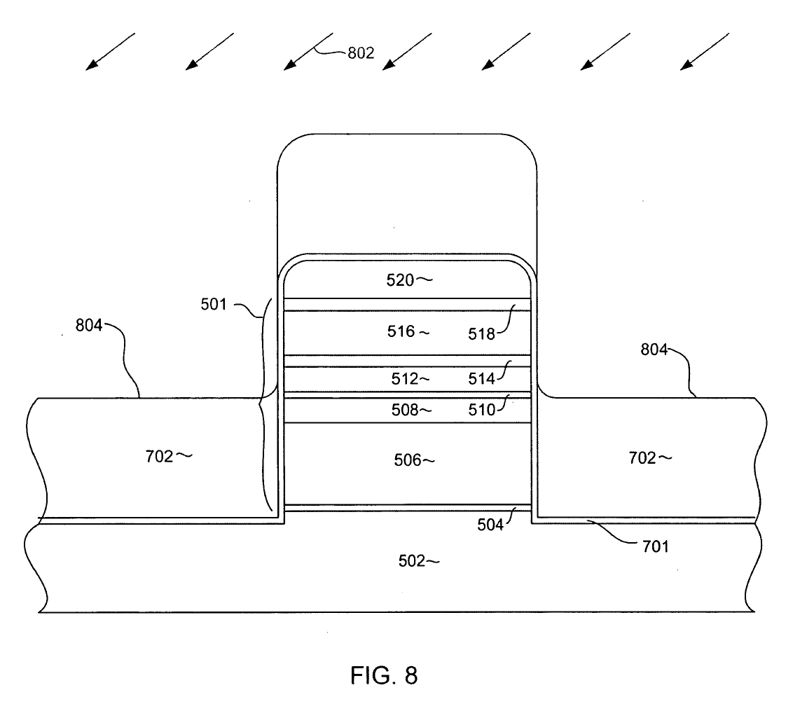

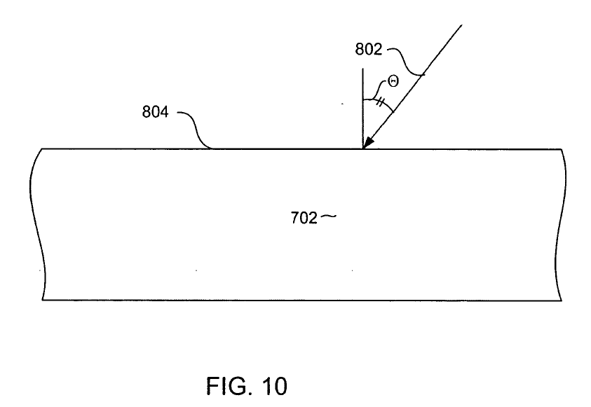

With reference to FIG. 8, a surface treatment is performed by directing an angled ion beam 802 at the surface 804 of the deposited under-layer 702 to create an anisotropic texture on the surface 804 of the under-layer 702. The angled ion milling can be performed by directing the ion beam 802 at an angle of about 60 degrees (30-85 degrees) relative to normal. This angled ion milling will be described in greater detail below with reference to FIGS. 10-12. The under-layer 702 is deposited to such a thickness that after the angled ion milling treatment, the under-layer 702 will have a desired thickness. For example, the under-layer can be deposited to a thickness of 40-170 Angstroms or about 90 Angstroms. Tile angled ion milling may then remove about 30 Angstroms of the under-layer 702, leaving a under-layer having a thickness of 10-150 Angstroms or about 60 Angstroms.

As will be understood by those skilled in the art, the layers 502-520 and 702 are deposited on a structure formed on a wafer that is held on a chuck within a tool such as a sputter deposition tool. The angled ion milling is performed by directing the angled ion beam 802 onto the surface 804 of the under-layer 702 while the chuck is held stationary. In other words the angled ion milling is not a sweeping ion mill and is not performed while rotating the chuck. However, because of shadowing from the substantially tall sensor stack structure (layers 506-520), the ion milling 802 may only be able to etch the under-layer 702 on one side of the sensor stack at regions close to the sensor stack. Therefore, in order to effectively treat the under-layer 702 on both sides of the sensor stack and improve within wafer uniformity, the ion milling can preferably be performed as a two step process, by performing a first in milling, then rotating the chuck 180 degrees, and then performing a second ion milling.

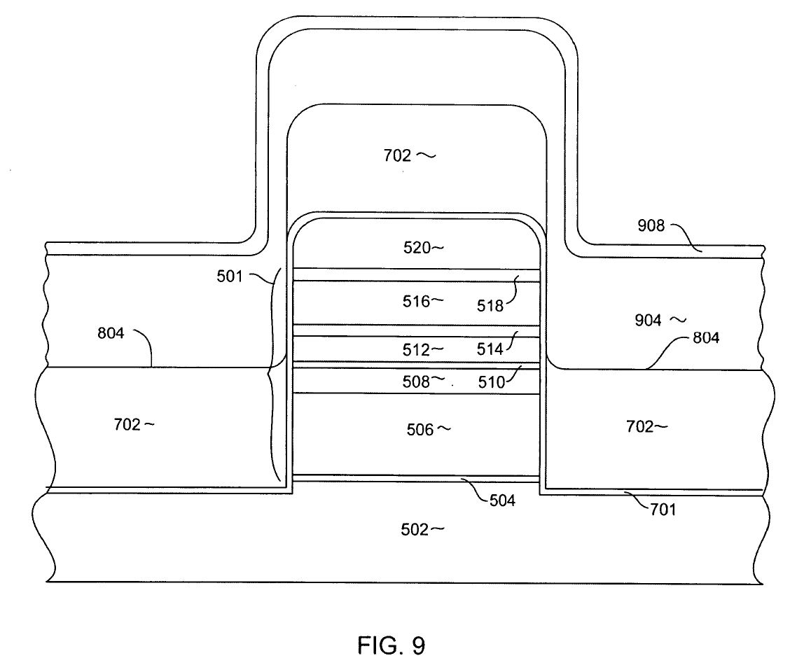

With reference now to FIG. 9, a layer of hard magnetic material 904 such as CoPt or CoPtCr is deposited over the under-layer 702. Then, a capping layer 908 such as Ta can be deposited over the hard magnetic layer 904. After the various layers have been deposited, a chemical mechanical polishing process (CMP) or other similar process can be performed to remove the mask 520 from over the sensor area and to remove the layers 701, 702, 904, and 908 protruding upward over the mask 520.

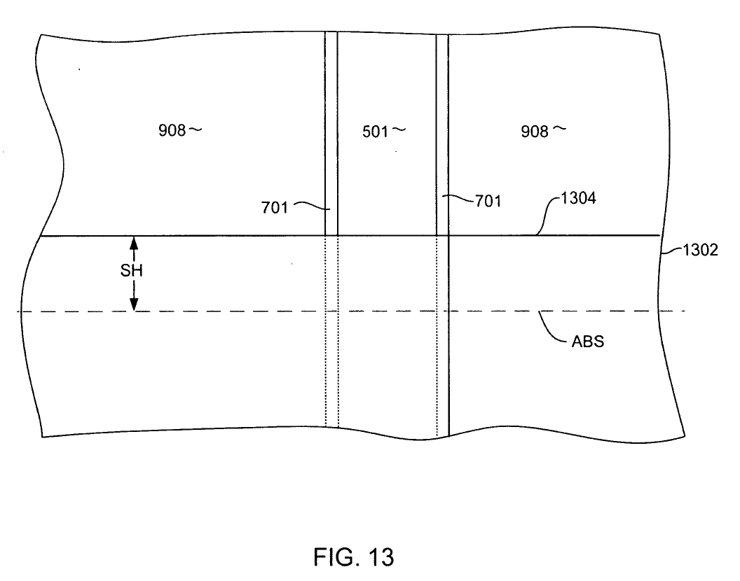

With reference now to FIG. 13, which shows a top down view showing the hard bias material layer covered by its capping layer 908 and sensor stack 501 a second mask structure 1302 is formed having a back edge 1304 that is located so as to define a stripe height SH as measured from an air bearing surface (ABS) indicated as a dashed line in FIG. 13. As those skilled in the art will appreciate, the air bearing surface will be formed at a later fabrication point by a lapping process after slicing the wafer into rows. After forming the mask 1302 a material removal process such as ion milling can be performed to remove portions of the sensor stack 501 and hard bias layers 904 that are not protected by the mask 1302, thereby defining the stripe height SH of the sensor stack 501 and hard bias layers 904.

Although, the above embodiments have been described with reference to a current perpendicular to plane (CPP) giant magnetoresistive (GMR) sensor, it should be pointed out that this is by way of example only. The enhanced free layer biasing provided by the present invention can be employed in many other types of sensors. For example, the biasing enhancements described above could be employed in a current in plane (CIP) GMR sensor or in a tunnel valve (TMR).

With reference to FIGS. 10-12, a surface treatment used to form an anisotropic roughness on the surface 804 of the under-layer 702 will be described in greater detail. With particular reference to FIG. 10, the under-layer 702 is deposited. A low power ion milling is then performed by directing an ion beam 802 at an angle θ greater than zero and less than 90 degrees (preferably 30-85 degrees or about 60 degrees) with respect to a normal to the surface 804 of the under-layer 702 (or with respect to a normal to the wafer, not shown). The ion milling 802 is preferably performed at a voltage of 20-500 Volts or about 50 Volts.

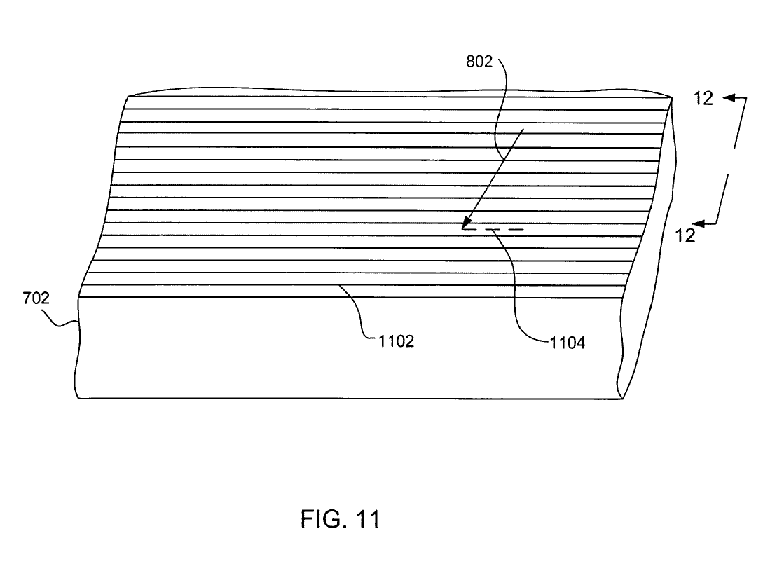

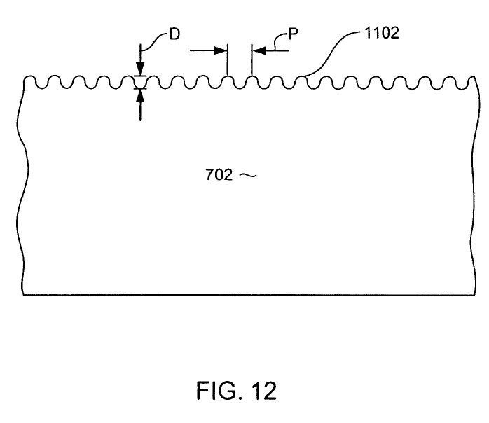

The angled ion milling induces anisotropic roughness, which may be in the form of, for example, oriented ripples or facets 1102 which can be seen with reference to FIGS. 11 and 12. The typical or average pitch P of the ripples 1102 may be between about 1-200 nm, their average depth D may be between approximately 0.2 to 5 nm or about 0.5 nm. Although shown as uniform ripples in FIGS. 11 and 12, this is for purposes of illustration. The actual surface would more likely be in the form of a more random and irregular surface roughness that is generally oriented and configured as described. After the angled ion milling 802 has been performed sufficiently to form the desired ripples or facets 1102 on the surface of the under layer 702, the hard bias layer 904 can be formed by depositing high coercivity magnetic material such as, for example CoPt or CoPtCr. Depending on the material being treated and the manufacturing conditions, the magnetic easy axis 352 (FIG. 3), of the applied hard bias layer 904 (338 in FIG. 3) may be substantially perpendicular to the in plane projection 1104 (FIG. 11) of the angled ion beam 802 onto the surface of the under-layer 702. Under certain manufacturing conditions and materials being treated, the magnetic easy axis may be either substantially parallel or substantially perpendicular to the in-plane projection 1104 of the angled ion beam 802. The direction of the ion milling must be chosen such that the resulting magnetic easy axis of the hard magnetic bias layers is substantially parallel to the ABS.

The exact voltage, current, and angle conditions for the ion milling 802 depend on the type and characteristics of the ion source in use. However, the ion milling 802 is preferably performed at the angle, voltage and duration described above.

While various embodiments have been described above, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetoresistive sensor, comprising:
a sensor stack that includes a magnetic pinned layer a magnetic free layer and a non-magnetic layer sandwiched between the pinned layer and the free layer, the sensor stack having first and second laterally opposed sides;
a bias structure formed adjacent to at least one of the first and second sides of the sensor stack the bias structure comprising:
an under-layer; and
a hard magnetic material (hard bias layer) formed over the under-layer; wherein:
the under-layer has a surface that is configured with an anisotropic texture that induces a magnetic anisotropy in the hard bias layer;
the hard magnetic material has a stripe height (SH) that is measured from an air bearing surface to a back edge of the hard magnetic material;
the hard magnetic material extends a distance W as measured in a direction away from the sensor stack and parallel to the air bearing surface; and
W is greater than SH.

2. A magnetoresistive sensor as in claim 1 wherein the W/SH is at least 4.

3. A magnetoresistive sensor as in claim 1 wherein the anisotropic surface texture is in the form of uniaxial facets.

4. A magnetoresistive sensor as in claim 1 wherein the anisotropic surface texture is in the form of uniaxial facets having an average pitch of 1-200 nm.

5. A magnetoresistive sensor as in claim 1 wherein the anisotropic surface texture is in the form of uniaxial facets having an average depth of 0.2 to 5 nm.

6. A magnetoresistive sensor as in claim 1 wherein the anisotropic surface texture is in the form of uniaxial facets having an average pitch of 1-200 nm and an average depth of 0.2 to 5 nm.

7. A magnetoresistive sensor as in claim 1 wherein the sensor is a current perpendicular to plane sensor further comprising first and second electrically conductive leads, the sensor stack being sandwiched between the first and second electrically conductive leads.

8. A magnetoresistive sensor as in claim 1 wherein the sensor is a tunnel valve sensor, and wherein the non-magnetic layer sandwiched between the pinned layer and the free layer is a non-magnetic, electrically insulating barrier layer.

9. A magnetoresistive sensor as in claim 1 wherein the sensor is a giant magnetoresistive sensor (GMR) and wherein the non-magnetic layer sandwiched between the free layer and the pinned layer is a non-magnetic, electrically conductive spacer layer.

10. A magnetoresistive sensor as in claim 1 wherein the sensor is a current in plane (CIP) giant magnetoresistive (GMR) sensor.

11. A method for manufacturing a magnetoresistive sensor, comprising:
forming a sensor stack on a wafer, the sensor stack having a magnetic free layer, a magnetic pinned layer and having first and second laterally opposed sides;
depositing an under-layer;
performing an angled ion milling on the Surface of the under-layer to form an anisotropic texture on the surface of the under-layer;
depositing a magnetic bias material over the under-layer, the anisotropic texture of the surface of the under-layer inducing a magnetic anisotropy in the deposited magnetic bias layer, the magnetic bias material being formed to extend a width W measured away from the sensor stack and parallel with an air bearing surface; and
forming the sensor stack and hard bias layer with a common back edge that defines a stripe height SH measured from an air bearing surface plane to the back edge; and wherein the W is greater than SH.

12. A method as in claim 11 wherein W is at least 4 times SH.

13. A method as in claim 11 wherein the angled ion milling is performed at an angle of less than 90 degrees and greater than 0 degrees relative to a normal to the wafer.

14. A method as in claim 11 wherein the angled ion milling is performed at an angle of about 60 degrees relative to a normal to the wafer.

15. A method as in claim 11 wherein the angled ion milling is performed at a voltage of 20-500 V.

16. A method as in claim 11 wherein the angled ion milling is performed at a voltage of about 50 V.

17. A method as in claim 11 wherein the under-layer comprises Ru.

18. A method as in claim 11 wherein the under-layer comprises Ru and is deposited to a thickness of 30-170 Angstroms.

19. A method as in claim 11 further comprising, after performing the angled ion milling to form an anisotropic texture on the surface of the under-layer, rotating the wafer 180 degrees and then performing a second angled ion milling.

20. A magnetic data recording system, comprising:
a housing;
a magnetic medium, rotatably mounted within the housing;
an actuator;
a slider connected with the actuator for movement adjacent to a surface of the magnetic medium; and
a magnetoresistive sensor formed on the slider, the magnetoresistive sensor further comprising:
a sensor stack that includes a magnetic pinned layer a magnetic free layer and a non-magnetic layer sandwiched between the pinned layer and the free layer, the sensor stack having first and second laterally opposed sides;
a bias structure formed adjacent to at least one of the first and second sides of the sensor stack the bias structure comprising:
an under-layer; and
a hard magnetic material (hard bias layer) formed over the under-layer; wherein:
the under-layer has a surface that is configured with an anisotropic texture that induces a magnetic anisotropy in the hard bias layer;
the hard magnetic material has a stripe height (SH) that is measured from an air bearing surface to a back edge of the hard magnetic material;
the hard magnetic material extends a distance W as measured in a direction away from the sensor stack and parallel to the air bearing surface; and
W is greater than SH.
